(19) United States
(12) Patent Application Publication
(10) Pub. No.: US 2020/0174171 A1
(43) Pub. Date: Jun. 4, 2020

(54) OPTICALLY ANISOTROPIC FILM, CIRCULARLY POLARIZING PLATE, AND DISPLAY DEVICE

(71) Applicant: FUJIFILM Corporation, Tokyo (JP)

(72) Inventors: Hideyuki NISHIKAWA, Kanagawa (JP); Mayumi NOJIRI, Kanagawa (JP); Ryoji GOTO, Kanagawa (JP)

(73) Assignee: FUJIFILM Corporation, Tokyo (JP)

(21) Appl. No.: 16/781,477

(22) Filed: Feb. 4, 2020

Related U.S. Application Data
(63) Continuation of application No. PCT/JP2018/031841, filed on Aug. 28, 2018.

(30) Foreign Application Priority Data
Aug. 28, 2017 (JP) 2017-163094

(51) Int. Cl. G02B 5/30; C09K 19/60; C09K 19/38

(52) U.S. Cl. CPC G02B 5/3016; C09K 19/3861; C09K 19/60

(57) ABSTRACT

The present invention provides an optically anisotropic film exhibiting excellent reciprocal wavelength dispersion, a circularly polarizing plate, and a display device. The optically anisotropic film of an embodiment of the present invention is an optically anisotropic film formed from a composition including a liquid crystal compound and an infrared absorbing dye, in which the optically anisotropic film satisfies a relationship of Formula (A): Re(450)/Re(550)<1, and an absorption at a wavelength of 700 to 900 nm in the fast axis direction of the optically anisotropic film is larger than an absorption at a wavelength of 700 to 900 nm in the slow axis direction of the optically anisotropic film. In Formula (A), Re(450) represents an in-plane retardation of the optically anisotropic film at a wavelength of 450 nm and Re(550) represents an in-plane retardation of the optically anisotropic film at a wavelength of 550 nm.

### CROSS-REFERENCE TO RELATED APPLICATIONS

This application is a Continuation of PCT International Application No. PCT/JP2018/031841 filed on Aug. 28, 2018, which claims priority under 35 U.S.C. § 119(a) to Japanese Patent Application No. 2017-163094 filed on Aug. 28, 2017. The above application is hereby expressly incorporated by reference, in its entirety, into the present application.

### BACKGROUND OF THE INVENTION

### 1. Field of the Invention

The present invention relates to an optically anisotropic film, a circularly polarizing plate, and a display device.

### 2. Description of the Related Art

A phase difference film having refractive index anisotropy (optically anisotropic film) has been applied to various applications such as an antireflection film of a display device and an optical compensation film of a liquid crystal display device.

In recent years, optically anisotropic films exhibiting reciprocal wavelength dispersion have been studied (JP2008-273925A). In addition, the reciprocal wavelength dispersion means a “negative dispersion” characteristic showing an increase in a birefringence in accordance with an increase in a measurement wavelength in at least a part of a wavelength range in the visible region.

### SUMMARY OF THE INVENTION

On the other hand, a reciprocal wavelength dispersion exhibited by optically anisotropic films in the related art has not necessarily been sufficient, and accordingly, a further improvement has been required.

More specifically, in a case of taking an example in which a λ/4 plate (1/λ wavelength plate) is taken as an optically anisotropic film, it is ideal that a phase difference in the visible region becomes a ¼ wavelength of a measurement wavelength. However, in optically anisotropic films in the related art, there is a tendency that a deviation from an ideal curve appears on the long wavelength side in the visible region. In addition, in the present specification, the optical characteristics which are closer to the ideal curve indicate that the reciprocal wavelength dispersion is excellent.

Taking the above circumstances into consideration, the present invention has an object to provide an optically anisotropic film exhibiting excellent reciprocal wavelength dispersion.

In addition, the present invention has another object to provide a circularly polarizing plate and a display device.

The present inventors have conducted extensive studies on problems in the related art, and as a result, they have found that the objects can be accomplished by the following configurations.

(1) An optically anisotropic film formed from a composition including a liquid crystal compound and an infrared absorbing dye,

in which the optically anisotropic film satisfies a relationship of Formula (A), and

an absorption at a wavelength of 700 to 900 nm in the fast axis direction of the optically anisotropic film is larger than an absorption at a wavelength of 700 to 900 nm in the slow axis direction of the optically anisotropic film,

Re(450)/Re(550)<1 Formula (A)

in the formula, Re(450) represents an in-plane retardation of the optically anisotropic film at a wavelength of 450 nm and Re(550) represents an in-plane retardation of the optically anisotropic film at a wavelength of 550 nm.

(2) The optically anisotropic film as described in (1),

in which an orientational order parameter S₀ of the optically anisotropic film at a maximum absorption wavelength in a wavelength range of 700 to 900 nm of the infrared absorbing dye satisfies a relationship of Formula (B),

−0.50<S₀<−0.15. Formula (B)

(3) An optically anisotropic film formed from a composition including a liquid crystal compound and an infrared absorbing dye,

in which an orientational order parameter S₀ of the optically anisotropic film at a maximum absorption wavelength in a wavelength range of 700 to 900 nm of the infrared absorbing dye satisfies a relationship of Formula (B), and

an absorption at a wavelength of 700 to 900 nm in the fast axis direction of the optically anisotropic film is larger than an absorption at a wavelength of 700 to 900 nm in the slow axis direction of the optically anisotropic film,

−0.50<S₀<−0.15. Formula (B)

(4) The optically anisotropic film as described in any one of (1) to (3),

in which an integrated value of the absorbances in a wavelength range of 700 to 900 nm of the infrared absorbing dye is larger than an integrated value of the absorbances in a wavelength range of 400 to 700 nm of the infrared absorbing dye.

(5) The optically anisotropic film as described in any one of (1) to (4),

in which the infrared absorbing dye is a compound represented by Formula (1) which will be described later.

(6) The optically anisotropic film as described in any one of(1) to (5),

in which an in-plane retardation at a wavelength of 550 nm is 110 to 160 nm.

(7) A circularly polarizing plate comprising:

the optically anisotropic film as described in (6); and a polarizer.

(8) A display device comprising:

a display element; and

the circularly polarizing plate as described in (7), arranged on the display element.

According to the present invention, it is possible to provide an optically anisotropic film exhibiting excellent reciprocal wavelength dispersion.

In addition, according to the present invention, it is also possible to provide a circularly polarizing plate and a display device.

### BRIEF DESCRIPTION OF THE DRAWINGS

FIG. 1 is a view showing a comparison between the wavelength dispersion of an optically anisotropic film exhibiting reciprocal wavelength dispersion in the related art and the wavelength dispersion of an ideal birefringence Δn.

FIG. 2 is a view showing the wavelength dispersion characteristics with respect to a refractive index and an absorption coefficient of an organic molecule.

FIG. 3 is a view showing a comparison of the wavelength dispersion between an extraordinary ray refractive index ne and an ordinary ray refractive index no depending on the presence or absence of predetermined absorption characteristics.

### DESCRIPTION OF THE PREFERRED EMBODIMENTS

Hereinafter, the present invention will be described in detail. Furthermore, in the present specification, a numerical value range expressed using “to” means a range that includes the preceding and succeeding numerical values of “to” as the lower limit value and the upper limit value, respectively. Above all, terms used in the present specification will be described. In addition, a fast axis and a slow axis are each defined at 550 nm unless otherwise specified.

In the present invention, Re(λ) and Rth(λ) each represent an in-plane retardation and a thickness-direction retardation at a wavelength of λ. The wavelength of λ is taken as 550 nm unless otherwise specified.

In the present invention, Re(λ) and Rth(λ) are values measured with an AxoScan OPMF-1 (manufactured by OPTO SCIENCE, Inc.) at a wavelength of λ. In the AxoScan, an average refractive index ((nx+ny+nz)/3) and a film thickness (d (μm)) are input to calculate the following:

Slow axis direction (°)

Re(λ)=R0(λ)

Rth(λ)=((nx+ny)/2−nz)×d.

Incidentally, R0(λ), which is expressed in a numerical value calculated with the AxoScan OPMF-1, means Re(λ).

In the present specification, the refractive indices nx, ny, and nz are measured with a sodium lamp (A=589 nm) as a light source, using an Abbe refractometer (NAR-4T, manufactured by ATAGO Co., Ltd.). In a case where a wavelength dependence is measured, it can be measured with a multi-wavelength Abbe refractometer DR-M2 (manufactured by ATAGO Co., Ltd.) in combination with an interference filter.

In addition, values in Polymer Handbook (JOHN WILEY & SONS, INC) and catalogs of various optical films can be used. The average refractive index values of major optical films are exemplified as follows: cellulose acylate (1.48), a cycloolefin polymer (1.52), polycarbonate (1.59), polymethyl methacrylate (1.49), and polystyrene (1.59).

Moreover, in the present specification, “visible rays” are intended to mean a light at a wavelength of 400 nm or more and less than 700 nm. Furthermore, “infrared rays” are intended to mean a light at a wavelength of 700 nm or more. In addition, “ultraviolet rays” are intended to mean a light at a wavelength of 10 nm or more and less than 400 nm.

In addition, in the present specification, angles (for example, an angle of “90°”) and a relationship thereof (for example, “perpendicular” and “parallel”) include a range of errors tolerable in the technical field to which the present invention belongs. For example, the angles and a relationship thereof is meant to encompass a range of a strictly defined angle±10°, and the errors relative to being strictly defined angle are preferably 5° or less, and more preferably 3° or less.

In one of aspects of the optically anisotropic film of an embodiment of the present invention, an infrared absorbing dye is used and the absorption characteristics of the optically anisotropic film at a wavelength of 700 to 900 nm are controlled.

Hereinafter, the aspects of the present invention will be described in detail.

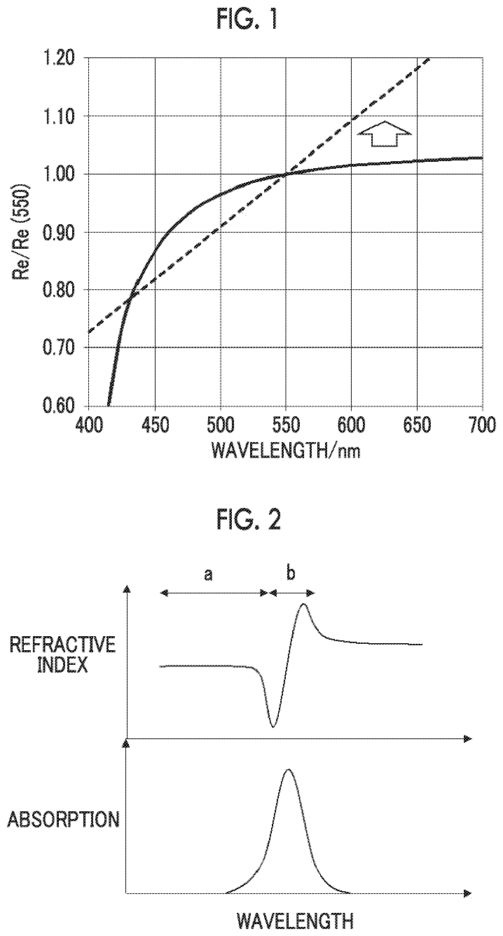

First, FIG. 1 shows the wavelength dispersion characteristics of a birefringence (Δn (λ)) at each wavelength in the visible region with a birefringence value (Δn (550 nm)) at a measurement wavelength of 550 nm being normalized as 1. For example, the above-mentioned ideal λ/4 plate has “negative dispersion” characteristics that a birefringence is larger as a measurement wavelength is longer since the birefringence is in a relationship in proportional with the measurement wavelength as shown with a dotted line in FIG. 1. In contrast, with regard to an optically anisotropic film exhibiting reciprocal wavelength dispersion in the related art, the wavelength dispersion characteristics are at a position overlapping the ideal curve shown with a dotted line in the short wavelength range, as shown with a solid line in FIG. 1 but also tend to deviate from the ideal curve in the long wavelength range, as shown in FIG. 1.

In the optically anisotropic film of the embodiment of the present invention, it is possible to approximate the optical characteristics in the long wavelength range to the ideal curve as shown with an outlined arrow by using an infrared absorbing dye and controlling the absorption characteristics at a wavelength of 700 to 900 nm of the optically anisotropic film.

A reason why the above characteristics are obtained will firstly be described with reference to FIG. 2 regarding the refractive index wavelength dispersion characteristics of a general organic molecules will be described. In FIG. 2, the upper side shows the behavior of a refractive index with respect to a wavelength, and the lower side shows the behavior (absorption spectrum) of absorption characteristics with respect to the wavelength.

For the organic molecule, a refractive index n in a region (a region a in FIG. 2) away from the intrinsic absorption wavelength decreases monotonically as the wavelength increases. Such the dispersion is referred to as “normal dispersion”. In contrast, a refractive index n in a wavelength band including an intrinsic absorption (a region b in FIG. 2) rapidly increases as the wavelength increases. Such the dispersion is referred to as “anomalous dispersion”.

That is, as shown in FIG. 2, an increase or a decrease in the refractive index is observed immediately before the wavelength range with the absorption.

In the optically anisotropic film of the embodiment of the present invention, the absorption at a wavelength of 700 to 900 nm in the fast axis direction becomes larger than the absorption at a wavelength of 700 to 900 nm in the slow axis direction under the influence of the infrared absorbing dye. Hereinafter, such absorption characteristics are also referred to as absorption characteristics X. As described in detail later, the absorption characteristics X are accomplished by arranging the axial direction having a high absorbance of the infrared absorbing dye in the optically anisotropic film to be in parallel with the fast axis direction. In the optically anisotropic film exhibiting the absorption characteristics X, the ordinary ray refractive index is further reduced, as compared with the optically anisotropic film not having absorption characteristics X.

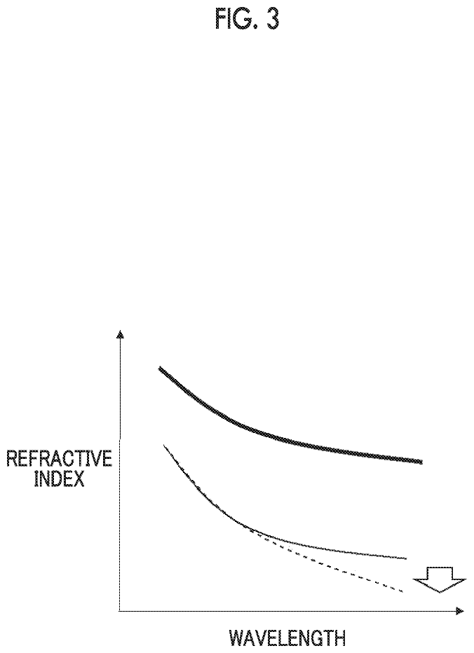

Specifically, FIG. 3 is view showing a comparison of the wavelength dispersion between an extraordinary ray refractive index ne and an ordinary ray refractive index no depending on the presence or absence of the absorption characteristics X. In FIG. 3, the thick line indicates a curve of the extraordinary ray refractive index ne in the absence of the absorption characteristics X, and the solid line shows a curve of the ordinary ray refractive index no in the absence of the absorption characteristics X. In contrast, in the optically anisotropic film of the embodiment of the present invention having the absorption characteristics X, a value of the ordinary ray refractive index no in the long wavelength range in the visible region is further reduced as shown with a broken line under the influence derived from an absorption at a wavelength of 700 to 900 nm as shown in FIG. 2. As a result, a birefringence Δn which is a difference between the extraordinary ray refractive index ne and the ordinary ray refractive index no is larger in the long wavelength range in the visible region, and thus, the behavior indicated with the arrow shown in FIG. 1 is accomplished.

Hereinafter, the configuration of the optically anisotropic film will be described in detail.

Furthermore, with regard to the description of the configuration of the optically anisotropic film, descriptions on each of the embodiments (a first embodiment and a second embodiment) will be made.

In addition, with regard to the description of a composition used to form an optically anisotropic film, and the description of a method for producing the optically anisotropic film, applications, and the like, as will be described later, the first embodiment and the second embodiment will be summarized.

### First Embodiment

The first embodiment of the optically anisotropic film satisfies a relationship of Formula (A).

Re(450)/Re(550)<1 Formula (A)

Re(450) represents an in-plane retardation of the optically anisotropic film at a wavelength of 450 nm and Re(550) represents an in-plane retardation of the optically anisotropic film at a wavelength of 550 nm.

Among those, Re(450)/Re(550) is preferably 0.97 or less, more preferably 0.92 or less, and still more preferably 0.87 or less. A lower limit thereof is not particularly limited, but is 0.75 or more in many cases.

Re(650)/Re(550) of the first embodiment of the optically anisotropic film is not particularly limited, but is preferably 1.05 or more, more preferably 1.08 or more, and still more preferably 1.10 or more. An upper limit thereof is not particularly limited, but is preferably 1.25 or less, and more preferably 1.20 or less.

In addition, Re(650) represents an in-plane retardation of the optically anisotropic film at a wavelength of 650 nm.

Re(550) of the first embodiment of the optically anisotropic film is not particularly limited, but from the viewpoint that the optically anisotropic film is useful as a λ/4 plate, Re(550) is preferably 110 to 160 nm, and more preferably 120 to 150 nm.

The thickness of the first embodiment of the optically anisotropic film is not particularly limited, but from the viewpoint of reducing the thickness of the phase difference film, it is preferably 10 μm or less, more preferably 0.5 to 8.0 μm, and still more preferably 0.5 to 6.0 μm.

In addition, in the present specification, the thickness of the optically anisotropic film is intended to mean an average thickness of the optically anisotropic film. The average thickness is obtained by measuring the thickness at any five or more points of the optically anisotropic film and determining an arithmetic mean of the values.

In the first embodiment of the optically anisotropic film, the absorption at a wavelength of 700 to 900 nm in the fast axis direction of the optically anisotropic film (hereinafter also referred to as an “absorption F”) is larger than the absorption at a wavelength of 700 to 900 nm in the slow axis direction of the optically anisotropic film (hereinafter also referred to as an “absorption S”).

An expression, “the absorption F is larger than the absorption S”, is intended to meant that a maximum absorbance in a wavelength range of 700 to 900 nm of an absorption spectrum obtained upon irradiation of the optically anisotropic film with polarized light in parallel with the fast axis of the optically anisotropic film is larger than a maximum absorbance in a wavelength range of 700 to 900 nm of an absorption spectrum obtained upon irradiation of the optically anisotropic film with polarized light in parallel with the slow axis of the optically anisotropic film.

In addition, the measurement can be carried out using a spectrophotometer (MPC-3100 manufactured by SHIMADZU Corporation) comprising a polarizer for infrared rays.

Moreover, the anisotropy of the absorption as described above can be realized by using an infrared absorbing dye as will be described later. In particular, it is possible to make the absorption F larger than the absorption S by setting the axial direction having a higher absorbance of the dye to be in parallel with the fast axis direction of the optically anisotropic film, using a dichroic infrared absorbing dye.

In the first embodiment of the optically anisotropic film, the orientational order parameter S₀ of the optically anisotropic film at the maximum absorption wavelength in the wavelength range of 700 to 900 nm of the infrared absorbing dye is not particularly limited, and is more than −0.50 and −0.10 or less in many cases. In a case where the orientational order parameter S₀ is large, it is possible to improve the reciprocal wavelength dispersion of the optically anisotropic film even with a reduction in the amount of the infrared absorbing dye. As a result, from the viewpoint the brightness of an organic electroluminescence (EL) display device is more excellent in a case the optically anisotropic film is applied as an antireflection film of the organic EL display device, it is preferable to satisfy a relationship of Formula (B).

−0.50<S₀<−0.15 Formula (B)

Among those, the orientational order parameter S₀ is more preferably −0.40 to −0.20, and still more preferably −0.30 to −0.20.

In the present specification, the orientational order parameter S₀(λ) of the optically anisotropic film at a wavelength of X nm is a value represented by Formula (C).

S₀(λ)=(Aₚ−Aᵥ)/(Aₚ+2Aᵥ) Formula (C)

In Formula (C), Aₚ represents an absorbance for light which is polarized in the direction in parallel with the slow axis direction of the optically anisotropic film. Aᵥ represents an absorbance for light which is polarized in the direction perpendicular to the slow axis direction of the optically anisotropic film.

The orientational order parameter S₀ (λ) of the optically anisotropic film can be determined by measuring a polarized light absorption of the optically anisotropic film. The measurement above can be carried out using a spectrophotometer (MPC-3100 (manufactured by SHIMADZU Corporation)) comprising a polarizer for infrared rays. λ is the maximum absorption wavelength of the absorption spectrum in a wavelength range of 700 to 900 nm obtained by measuring the absorption of the optically anisotropic film.

### Second Embodiment

In the second embodiment of the optically anisotropic film, the orientational order parameter S₀ of the optically anisotropic film at the maximum absorption wavelength in a wavelength range of 700 to 900 nm of the infrared absorbing dye satisfies a relationship of Formula (B).

−0.50<S₀<−0.15 Formula (B)

Among those, the orientational order parameter S₀ is more preferably −0.40 to −0.20, and still more preferably −0.30 to −0.20.

A method for measuring the orientational order parameter S₀ (λ) of the optically anisotropic film is as described in <First Embodiment> above.

In the second embodiment of the optically anisotropic film, the absorption (absorption F) at a wavelength of 700 to 900 nm in the fast axis direction of the optically anisotropic film is larger than the absorption (absorption S) at a wavelength of 700 to 900 nm in the slow axis direction of the optically anisotropic film.

An expression, “the absorption F is larger than the absorption S”, is intended to meant that a maximum absorbance in a wavelength range of 700 to 900 nm of an absorption spectrum obtained upon irradiation of the optically anisotropic film with polarized light in parallel with the fast axis of the optically anisotropic film is larger than a maximum absorbance in a wavelength range of 700 to 900 nm of an absorption spectrum obtained upon irradiation of the optically anisotropic film with polarized light in parallel with the slow axis of the optically anisotropic film.

In addition, the measurement can be carried out using a spectrophotometer (MPC-3100 manufactured by SHIMADZU Corporation) comprising a polarizer for infrared rays.

In addition, the anisotropy of the absorption as described above can be realized by using an infrared absorbing dye as will be described later. In particular, it is possible to make the absorption F larger than the absorption S by using a dichroic infrared absorbing dye to set the axial direction having a higher absorbance of the dye to be in parallel with the fast axis direction of the optically anisotropic film.

The second embodiment of the optically anisotropic film preferably satisfies a relationship of Formula (A).

Re(450)/Re(550)<1 Formula (A)

Re(450) represents an in-plane retardation of the optically anisotropic film at a wavelength of 450 nm, Re(550) represents an in-plane retardation of the optically anisotropic film at a wavelength of 550 nm.

Among those, Re(450)/Re(550) is preferably 0.97 or less, more preferably 0.92 or less, and still more preferably 0.87 or less. A lower limit thereof is not particularly limited, but is 0.75 or more in many cases.

Re(650)/Re(550) of the second embodiment of the optically anisotropic film is not particularly limited, but is preferably 1.05 or more, more preferably 1.08 or more, and still more preferably 1.10 or more. An upper limit thereof is not particularly limited, but is preferably 1.25 or less, and more preferably 1.20 or less.

In addition, Re(650) represents an in-plane retardation of the optically anisotropic film at a wavelength of 650 nm.

Re(550) of the second embodiment of the optically anisotropic film is not particularly limited, but from the viewpoint that the optically anisotropic film is useful as a λ/4 plate, Re(550) is preferably 110 to 160 nm, and more preferably 120 to 150 nm.

The thickness of the second embodiment of the optically anisotropic film is not particularly limited, but from the viewpoint of reducing the thickness of the phase difference film, it is preferably 10 μm or less, more preferably 0.5 to 8.0 μm, and still more preferably 0.5 to 6.0 μm.

A method for measuring thickness of the optically anisotropic film is as described in <First Embodiment> above.

<Composition>

The optically anisotropic film of the embodiment of the present invention is a layer formed from a composition including a liquid crystal compound and an infrared absorbing dye. Hereinafter, materials used will be described in detail, and then a method for producing the optically anisotropic film will be described in detail.

<Liquid Crystal Compound>

The type of the liquid crystal compound is not particularly limited, but the liquid crystal compounds may be classified into a rod-shaped type (a rod-shaped liquid crystal compound) and a disk-shaped type (a discotic liquid crystal compound or a disk-like liquid crystal compound), depending on a shape thereof. Each of the types can further be classified into a low-molecular type and a high-molecular type. The high molecular one generally refers to a type showing a degree of polymerization of 100 or more (Polymer Physics-Phase Transition Dynamics, by Masao Doi, page 2, published by Iwanami Shoten, Publishers, 1992). In addition, two or more kinds of the rod-shaped liquid crystal compounds, two or more kinds of the disk-shaped liquid crystal compounds, or a mixture of the rod-shaped liquid crystal compound and the disk-shaped liquid crystal compound may be used.

The position of the maximum absorption wavelength of the liquid crystal compound is not particularly limited, but from the viewpoint that the effect of the present invention is more excellent, it is preferable that the maximum absorption wavelength is positioned in the ultraviolet region.

From the viewpoint that changes in the temperature and the humidity of the optical characteristics can be suppressed, a liquid crystal compound (rod-shaped liquid crystal compound or disk-like liquid crystal compound) having a polymerizable group is preferable as the liquid crystal compound. The liquid crystal compounds may be a mixture of two or more kinds thereof, and in this case, it is preferable that at least one has 2 or more polymerizable groups.

That is, it is preferable that the optically anisotropic film is a layer formed by the fixation of the liquid crystal compound (rod-shaped liquid crystal compound or disk-like liquid crystal compound) having a polymerizable group by polymerization or the like, and in this case, it is not necessary to exhibit the liquid crystallinity any longer after forming the layer.

The type of the polymerizable group is not particularly limited, and a polymerizable group which is radically polymerizable or cationically polymerizable is preferable.

A known radically polymerizable group can be used as the radically polymerizable group, and an acryloyl group or a methacryloyl group is preferable.

A known cationically polymerizable group can be used as the cationically polymerizable group, and specific examples thereof include an alicyclic ether group, a cyclic acetal group, a cyclic lactone group, a cyclic thioether group, a spiroorthoester group, and a vinyloxy group. Among those, the alicyclic ether group or the vinyloxy group is preferable, and the epoxy group, the oxetanyl group, or the vinyloxy group is more preferable.

In particular, preferred examples of the polymerizable group include the following groups.

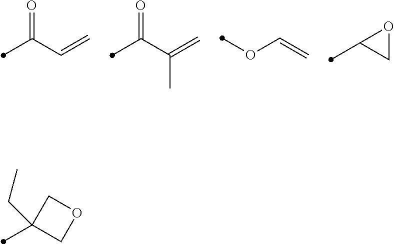

Among those, a compound represented by Formula (I) is preferable as the liquid crystal compound.

L¹-SP¹-A¹-D³-G¹-D¹-Ar-D²-G²-D⁴-A²-SP²-L² Formula (I)

In Formula (I), D¹, D², D³ and D⁴ each independently represent a single bond, —O—CO—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴-, —CR¹R²—CO—O—CR³R⁴-, —NR¹—CR²R³—, or —CO—NR¹—.

R¹, R², R³, and R⁴ each independently represent a hydrogen atom, a fluorine atom, or an alkyl group having 1 to 4 carbon atoms.

Moreover, in Formula (I), G¹ and G² each independently represent a divalent alicyclic hydrocarbon group having 5 to 8 carbon atoms, and one or more of —CH₂-'s constituting the alicyclic hydrocarbon group may be substituted with —O—, —S—, or —NH—.

Furthermore, in Formula (I), A¹ and A² each independently represent a single bond, an aromatic ring having 6 or more carbon atoms, or a cycloalkylene ring having 6 or more carbon atoms.

Moreover, in Formula (I), SP¹ and SP² each independently represent a single bond, a linear or branched alkylene group having 1 to 14 carbon atoms, or a divalent linking group in which one or more of —CH₂-'s constituting the linear or branched alkylene group having 1 to 14 carbon atoms are substituted with —O—, —S—, —NH—, —N(Q)-, or —CO—, and Q represents a polymerizable group.

Incidentally, in Formula (I), L¹ and L² each independently represent a monovalent organic group (for example, an alkyl group or a polymerizable group).

In addition, in a case where Ar is a group represented by Formula (Ar-1), Formula (Ar-2), Formula (Ar-4), or Formula (Ar-5) which will be described later, at least one of L¹ or L² represents a polymerizable group. In addition, in a case where Ar is a group represented by Formula (Ar-3) which will be described later, at least one of L¹ or L², or L³ or L⁴ in Formula (Ar-3) represents a polymerizable group.

In Formula (I), a 5- or 6-membered ring is preferable as the divalent alicyclic hydrocarbon group having 5 to 8 carbon atoms represented by each of G¹ and G². Further, the alicyclic hydrocarbon group may be either a saturated alicyclic hydrocarbon group or an unsaturated alicyclic hydrocarbon group, but is preferably the saturated alicyclic hydrocarbon group. With respect to the divalent alicyclic hydrocarbon group represented by each of G¹ and G², reference can be made to, for example, the description in paragraph [0078] of JP2012-021068A, the contents of which are incorporated herein by reference.

In Formula (I), examples of the aromatic ring having 6 or more carbon atoms represented by each of A¹ and A² include aromatic hydrocarbon rings such as a benzene ring, a naphthalene ring, an anthracene ring, and a phenanthroline ring: and aromatic heterocyclic rings such as a furan ring, a pyrrole ring, a thiophene ring, a pyridine ring, a thiazole ring, and a benzothiazole ring. Among those, the benzene ring (for example, a 1,4-phenyl group) is preferable. Furthermore, in Formula (I), examples of the cycloalkylene ring group having 6 or more carbon atoms represented by each of A¹ and A² include a cyclohexane ring group and a cyclohexene ring group, and among these, the cyclohexane ring (for example, a cyclohexane-1,4-diyl group) is preferable.

In Formula (1), as the linear or branched alkylene group having 1 to 14 carbon atoms represented by each of SP¹ and SP², a methylene group, an ethylene group, a propylene group, or a butylene group is preferable.

In Formula (I), the polymerizable group represented by each of L¹ and L² is not particularly limited, but a radically polymerizable group (a group which is radically polymerizable) or a cationically polymerizable group (a group which is cationically polymerizable) is preferable.

A suitable range of the radically polymerizable group is as described above.

On the other hand, in Formula (1), Ar represents any one aromatic ring selected from the group consisting of groups represented by Formulae (Ar-1) to (Ar-5). In addition, in Formulae (Ar-1) to (Ar-5), *1 represents a bonding position with D¹ and *2 represents a bonding position with D².

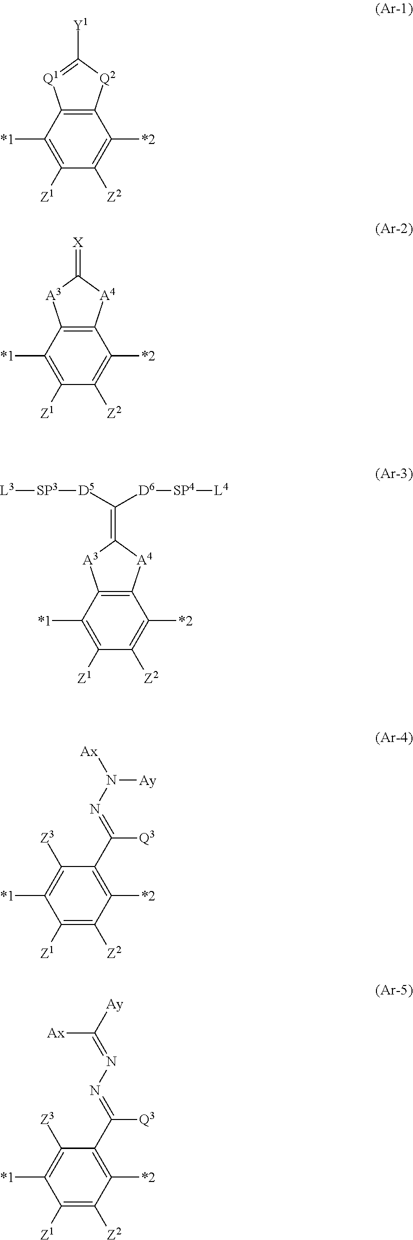

Here, in Formula (Ar-1), Q¹ represents N or CH, QL represents —S—, —O—, or —N(R⁵)—, R⁵ represents a hydrogen atom or an alkyl group having 1 to 6 carbon atoms, and Y¹ represents an aromatic hydrocarbon group having 6 to 12 carbon atoms or an aromatic heterocyclic group having 3 to 12 carbon atoms, each of which may have a substituent.

Examples of the alkyl group having 1 to 6 carbon atoms represented by R⁵ include a methyl group, an ethyl group, a propyl group, an isopropyl group, an n-butyl group, an isobutyl group, a sec-butyl group, a tert-butyl group, an n-pentyl group, and an n-hexyl group.

Examples of the aromatic hydrocarbon group having 6 to 12 carbon atoms represented by Y¹ include aryl groups such as a phenyl group, a 2,6-diethylphenyl group, and a naphthyl group.

Examples of the aromatic heterocyclic group having 3 to 12 carbon atoms represented by Y¹ include heteroaryl groups such as a thienyl group, a thiazolyl group, a furyl group, a pyridyl group, and a benzofuryl group. In addition, examples of the aromatic heterocyclic group further include a group formed by fusion of a benzene ring and an aromatic heterocyclic ring.

In addition, examples of the substituent which may be contained in Y¹ include an alkyl group, an alkoxy group, a nitro group, an alkylsulfonyl group, an alkyloxycarbonyl group, a cyano group, and a halogen atom.

As the alkyl group, for example, a linear, branched, or cyclic alkyl group having 1 to 18 carbon atoms is preferable, an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group) is more preferable, an alkyl group having 1 to 4 carbon atoms is still more preferable, and the methyl group or the ethyl group is particularly preferable.

As the alkoxy group, for example, an alkoxy group having 1 to 18 carbon atoms is preferable, an alkoxy group having 1 to 8 carbon atoms (for example, a methoxy group, an cthoxy group, an n-butoxy group, and a methoxyethoxy group) is more preferable, an alkoxy group having 1 to 4 carbon atoms is still more preferable, and the methoxy group or the ethoxy group is particularly preferable.

Examples of the halogen atom include a fluorine atom, a chlorine atom, a bromine atom, and an iodine atom, and the fluorine atom or the chlorine atom is preferable.

In addition, in Formulae (Ar-1) to (Ar-5), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —NRR⁷, or —SR⁸, R⁶ to R⁸ each independently represent a hydrogen atom or an alkyl group having 1 to 6 carbon atoms, and Z¹ and Z² may be bonded to each other to form a ring. The ring may be any one of an alicyclic ring, a heterocyclic ring, and an aromatic ring, and is preferably the aromatic ring. In addition, a ring thus formed may be substituted with a substituent.

As the monovalent aliphatic hydrocarbon group having 1 to 20 carbon atoms, an alkyl group having 1 to 15 carbon atoms is preferable, an alkyl group having 1 to 8 carbon atoms is more preferable, a methyl group, an ethyl group, an isopropyl group, a tert-pentyl group (1,1-dimethylpropyl group), a tert-butyl group, or a 1,1-dimethyl-3,3-dimethyl-butyl group is still more preferable, and the methyl group, the ethyl group, or the tert-butyl group is particularly preferable.

Examples of the monovalent alicyclic hydrocarbon group having 3 to 20 carbon atoms include a monocyclic saturated hydrocarbon group such as a cyclopropyl group, a cyclobutyl group, a cyclopentyl group, a cyclohexyl group, a cycloheptyl group, a cyclooctyl group, a cyclodecyl group, a methylcyclohexyl group, and ethylcyclohexyl group; a monocyclic unsaturated hydrocarbon group such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadienyl group; and a polycyclic saturated hydrocarbon group such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly a phenyl group) is preferable.

Examples of the halogen atom include a fluorine atom, a chlorine atom, a bromine atom, and an iodine atom, and the fluorine atom, the chlorine atom, or the bromine atom is preferable.

On the other hand, examples of the alkyl group having 1 to 6 carbon atoms represented by each of R⁶ to R⁸ include a methyl group, an ethyl group, a propyl group, an isopropyl group, an n-butyl group, an isobutyl group, a sec-butyl group, a tert-butyl group, an n-pentyl group, and an n-hexyl group.

In addition, in Formulae (Ar-2) and (Ar-3), A³ and A⁴ each independently represent a group selected from the group consisting of —O—, —N(R⁹)—, —S—, and —CO—, and R⁹ represents a hydrogen atom or a substituent.

Examples of the substituent represented by R⁹ include the same ones as the substituents which may be contained in Y¹ in Formula (Ar-1).

Furthermore, in Formula (Ar-2), X represents a hydrogen atom or a non-metal atom of Groups 14 to 16 to which a substituent may be bonded.

Moreover, examples of the non-metal atom of Groups 14 to 16 represented by X include an oxygen atom, a sulfur atom, a nitrogen atom having a substituent, and a carbon atom having a substituent, and examples of the substituent include the same ones as the substituents which may be contained in Y¹ in Formula (Ar-1).

In addition, in Formula (Ar-3), D⁵ and D⁶ each independently represent a single bond, —O—CO—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—. R¹, R², R³, and R⁴ each independently represent a hydrogen atom, a fluorine atom, or an alkyl group having 1 to 4 carbon atoms.

Moreover, in Formula (Ar-3), SP³ and SP⁴ each independently represent a single bond, a linear or branched alkylene group having 1 to 12 carbon atoms, or a divalent linking group in which one or more of —CH₂-'s constituting the linear or branched alkylene group having 1 to 12 carbon atoms are substituted with —O—, —S—, —NH—, —N(Q)-, or —CO—, and Q represents a polymerizable group.

Furthermore, in Formula (Ar-3), L³ and L⁴ each independently represent a monovalent organic group (for example, an alkyl group and a polymerizable group), and at least one of L³ or L⁴, or L¹ or L² in Formula (1) represents a polymerizable group.

Moreover, in Formulae (Ar-4) and (Ar-5), Ax represents an organic group having 2 to 30 carbon atoms, which has at least one aromatic ring selected from the group consisting of an aromatic hydrocarbon ring and an aromatic heterocyclic ring.

Furthermore, in Formulae (Ar-4) and (Ar-5), Ay represents a hydrogen atom, an alkyl group having 1 to 6 carbon atoms, which may have a substituent, or an organic group having 2 to 30 carbon atoms, which has at least one aromatic ring selected from the group consisting of an aromatic hydrocarbon ring and an aromatic heterocyclic ring.

Here, the aromatic rings in each of Ax and Ay may have a substituent, and Ax and Ay may be bonded to each other to form a ring.

In addition, Q³ represents a hydrogen atom or an alkyl group having 1 to 6 carbon atoms, which may have a substituent.

Examples of each of Ax and Ay include those described in paragraphs [0039] to [0095] of the pamphlet of WO2014/010325A.

Incidentally, examples of the alkyl group having 1 to 6 carbon atoms represented by Q³ include a methyl group, an ethyl group, a propyl group, an isopropyl group, an n-butyl group, an isobutyl group, a sec-butyl group, a tert-butyl group, an n-pentyl group, and an n-hexyl group, and examples of the substituent include the same ones as the substituents which may be contained in Y¹ in Formula (Ar-1).

Among those, from the viewpoint that the effect of the present invention is more excellent, it is preferable that at least one of A¹ or A² is a cycloalkylene ring having 6 or more carbon atoms, and it is more preferable that one of A¹ and A² is a cycloalkylene ring having 6 or more carbon atoms.

The content of the liquid crystal compound in the composition is not particularly limited, but is preferably 50% by mass or more, and more preferably 70% by mass or more, with respect to the total solid content in the composition. An upper limit thereof is not particularly limited, but is 90% by mass or less in many cases.

In addition, the total solid content in the composition does not include a solvent.

<Infrared Absorbing Dye>

The infrared absorbing dye is not particularly limited as long as it is a dye absorbing infrared rays (in particular, light at a wavelength of 700 to 900 nm). Among those, the infrared absorbing dye is preferably a dichroic dye. In addition, the dichroic dye refers to a dye having a property that an absorbance in the major axis direction and an absorbance in the minor axis direction in the molecule are different from each other.

Examples of the infrared absorbing dye include a diketopyrrolopyrrole-based dye, a diimmonium-based dye, a phthalocyanine-based dye, a naphthalocyanine-based dye, an azo-based dye, a polymethine-based dye, an anthraquinone-based dye, a pyrylium-based dye, a squarylium-based dye, a triphenylmethane-based dye, a cyanine-based dye, and an aminium-based dye.

The infrared absorbing dyes may be used singly or in combination of two or more kinds thereof.

From the viewpoint that the effect of the present invention is more excellent, it is preferable that the infrared absorbing dye has a mesogenic group. By incorporating the mesogenic group into the infrared absorbing dye, the infrared absorbing dye can be easily aligned with the above-mentioned liquid crystal compounds described and predetermined absorption characteristics can be easily controlled.

The mesogenic group is a functional group which is rigid and has alignment. Examples of a structure of the mesogenic groups include a structure formed by linking a plurality of groups selected from the group consisting of an aromatic ring group (an aromatic hydrocarbon ring group and an aromatic heterocyclic group) and an alicyclic group directly or via a linking group (for example, CO—, —O—, and —NR— (R represents a hydrogen atom or an alkyl group), or a group formed by combination thereof).

From the viewpoint that the effect of the present invention is more excellent, the maximum absorption wavelength of the infrared absorbing dye is preferably positioned at 650 to 1,000 nm, and more preferably positioned at 700 to 900 nm.

From the viewpoint that the effect of the present invention is more excellent, an integrated value of the absorbances in a wavelength range of 700 to 900 nm of the infrared absorbing dye is preferably larger than an integrated value of the absorbances in a wavelength range of 400 to 700 nm of the infrared absorbing dye.

The integrated value of the absorbances is a value obtained by summing the absorbance at the respective wavelengths ranging from X to Y nm.

The measurement can be carried out using a spectrophotometer (MPC-3100 manufactured by SHIMADZU Corporation).

Suitable aspects of the infrared absorbing dye include a compound represented by Formula (1).

The compound having a structure represented by Formula (1) has a less absorption in the visible region, and an optically anisotropic film thus obtained is further suppressed from being colored. In addition, from the viewpoint that the compound includes a group having a mesogenic group, the compound is easily aligned together with the liquid crystal compound. At this time, the group having a mesogenic group is arranged such that it extends horizontally from a fused ring moiety including a nitrogen atom at the center of the compound, and therefore, the fused ring moiety is easily aligned in the direction perpendicular to the slow axis of an optically anisotropic film thus formed. That is, an absorption in the infrared region (in particular, at a wavelength of 700 to 900 nm) derived from the fused ring moiety is easily obtained in the direction perpendicular to the slow axis of the optically anisotropic film, and an optically anisotropic film exhibiting desired characteristics is easily obtained.

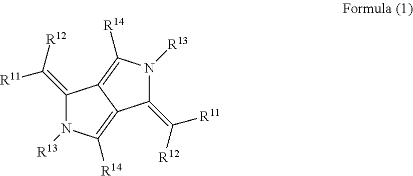

R¹¹ and R¹² each independently represent a hydrogen atom or a substituent, at least one thereof is an electron-withdrawing group, and R¹¹ and R¹² may be bonded to each other to form a ring.

Examples of the substituent include an alkyl group, an alkenyl group, an alkynyl group, an aryl group, an amino group, an alkoxy group, an aryloxy group, an aromatic heteroring oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, an aromatic heteroring thio group, a sulfonyl group, a sulfinyl group, a ureido group, a phosphoric acid amide group, a hydroxy group, a mercapto group, a halogen atom, a cyano group, a sulfo group, a carboxyl group, a nitro group, a hydroxamic acid group, a sulfino group, a hydrazino group, an imino group, a heterocyclic group, and a silyl group.

The electron-withdrawing group represents a substituent having a Hammett sigma para value (op value) of positive, and examples thereof include a cyano group, an acyl group, an alkyloxycarbonyl group, an aryloxycarbonyl group, a sulfamoyl group, a sulfinyl group, and a heterocyclic group.

These electron-withdrawing groups may further be substituted.

Here, the Hammett substituent constant value op will be described. The Hammett rule is an empirical rule proposed by L. P. Hammett in 1935 in order to quantitatively discuss an influence of a substituent exerted on a reaction or equilibrium of a benzene derivative, and nowadays, its validity has been widely recognized. The substituent constants required by the Hammett rule include a op value and a σm value, and these values are described in many general scientific articles. There are specific descriptions in, for example, “Lange's Handbook of Chemistry” edited by J. A. Dean, 12^{th} edition, 1979 (McGraw-Hill), “Region of Chemistry”, extra number, No. 122, pp. 96-103, 1979 (Nankodo Co., Ltd.), Chem. Rev., 1991, Vol. 91, pp. 165-195, and the like. As the electron-withdrawing group in the embodiment of the present invention, a substituent having a Hammett substituent constant op value of 0.20 or more is preferable. The up value is preferably 0.25 or more, more preferably 0.30 or more, and still more preferably 0.35 or more. An upper limit thereof is not particularly limited, but is preferably 0.80 or less.

Specific examples thereof include a cyano group (0.66), a carboxyl group (—COOH: 0.45), an alkoxycarbonyl group (—COOMe: 0.45), an aryloxycarbonyl group (—COOPh: 0.44), a carbamoyl group (—CONH₂: 0.36), an alkylcarbonyl group (—COMe: 0.50), an arylcarbonyl group (—COPh: 0.43), an alkylsulfonyl group (—SO₂Me: 0.72), and an arylsulfonyl group (—SO₂Ph: 0.68).

In the present specification, Me represents a methyl group and Ph represents a phenyl group. In addition, the values in parentheses are up values of the representative substituent as extracted from Chem. Rev., 1991, Vol. 91, pp. 165-195.

In a case where R¹¹ and R¹² are bonded to form a ring, R¹¹ and R¹² form a 5- to 7-membered ring (preferably a 5- or 6-membered ring), and it is typically preferable to use a ring thus formed as an acidic nucleus in a merocyanine dye.

As the ring formed by the bonding of R¹¹ and R¹², a 1,3-dicarbonyl nucleus, a pyrazolinone nucleus, a 2,4,6-triketohexahydropyrimidine nucleus (including a thioketone form), a 2-thio-2,4-thiazolidinedione nucleus, a 2-thio-2,4-oxazolidinedione nucleus, a 2-thio-2,5-thiazolidinedione nucleus, a 2,4-thiazolidinedione nucleus, a 2,4-imidazolidinedione nucleus, a 2-thio-2,4-imidazolidinedione nucleus, a 2-imidazolin-5-one nucleus, a 3,5-pyrazolidinedione nucleus, a benzothiophen-3-one nucleus, or an indanone nucleus is preferable.

R¹¹ is preferably a heterocyclic group. As the heterocyclic group, a pyrazole ring group, a thiazole ring group, an oxazole ring group, an imidazole ring group, an oxadiazole ring group, a thiadiazole ring group, a triazole ring group, a pyridine ring group, a pyridazine ring group, a pyrimidine ring group, a pyrazine ring group, such the benzo-fused ring or naphtho-fused ring, or a composite of these fused rings is preferable.

R¹³'s each independently represent a hydrogen atom, an alkyl group, an aryl group, a heteroaryl group, a substitutional boron, or a metal atom, or may be covalently bonded or coordinately bonded with R¹¹.

The substituent of the substitutional boron represented by R¹³ has the same definition as the above-mentioned substituent for each of R¹¹ and R¹², and is preferably an alkyl group, an aryl group, or a heteroaryl group.

In addition, the metal atom represented by R¹³ is preferably a transition metal atom, a magnesium atom, an aluminum atom, a calcium atom, a barium atom, a zinc atom, or a tin atom, and more preferably the aluminum atom, the zinc atom, the tin atom, the vanadium atom, the iron atom, the cobalt atom, the nickel atom, the copper atom, the palladium atom, the iridium atom, or the platinum atom.

R¹⁴'s each independently represent a group having a mesogenic group. The mesogenic group has the same definition as above.

R¹⁴ is preferably a group represented by Formula (2). * represents a bonding position.

*-M¹-(X¹-M²)ₙ—X²—P Formula (2)

M¹ represents a substituted or unsubstituted arylene group, or a substituted or unsubstituted heteroarylene group. Examples of the arylene group include a phenylene group.

X¹ and X² each independently represent a single bond, —O—, —CO—, —CH₂—, —CH═CH—, —C≡C—, —NR⁰—, or a combination thereof (for example, —O—CO— and —CH₂—CH₂—). R⁰ represents a hydrogen atom or an alkyl group having 1 to 5 carbon atoms.

M² represents a substituted or unsubstituted arylene group, a substituted or unsubstituted heteroarylene group, or a substituted or unsubstituted cycloalkylene group.

n represents 1 to 5. Among those, n is preferably 2 to 4.

P represents a hydrogen atom or a polymerizable group. The polymerizable group has the same definition as the polymerizable group which may be contained in the above-mentioned liquid crystal compound.

The infrared absorbing dye is more preferably a compound represented by Formula (3).

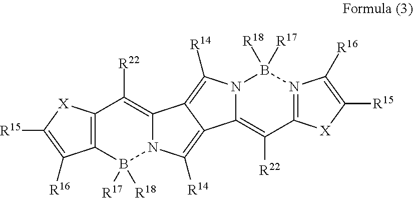

R¹⁴ has the same definition as above.

R²²'s each independently represent a cyano group, an acyl group, an alkoxycarbonyl group, an alkylsulfinyl group, an arylsulfinyl group, or a nitrogen-containing heteroaryl group.

R¹⁵ and R¹⁶ each independently represent a hydrogen atom, an alkyl group, an alkoxy group, an aryl group, or a heteroaryl group, and R¹⁵ and R¹⁶ may be bonded to each other to form a ring. Examples of the ring formed include an alicycle having 5 to 10 carbon atoms, an aryl ring having 6 to 10 carbon atoms, or a heteroaryl ring having 3 to 10 carbon atoms.

R¹⁷ and R¹⁸ each independently represent an alkyl group, an alkoxy group, an aryl group, or a heteroaryl group.

X's each independently represent an oxygen atom, a sulfur atom, —NR—, —CRR′—, or —CH—CH—, and R and R′ each independently represent a hydrogen atom, an alkyl group, or an aryl group.

The content of the infrared absorbing dye in the composition is not particularly limited, but from the viewpoint that the effect of the present invention is more excellent, the content is preferably 5% to 70% by mass, and more preferably 10% to 50% by mass, with respect to the total mass of the liquid crystal compound.

<Other Components>

The composition may include components other than the above-mentioned liquid crystal compound and infrared absorbing dye.

The composition may contain a polymerization initiator. The polymerization initiator to be used is selected according to the type of polymerization reaction, and examples thereof include a thermal polymerization initiator and a photopolymerization initiator. Examples of the photopolymerization initiator include an α-carbonyl compound, an acyloin ether, an α-hydrocarbon substituted aromatic acyloin compound, a polynuclear quinone compound, and a combination of a triarylimidazole dimer and a p-aminophenyl ketone.

The content of the polymerization initiator in the composition is preferably 0.01% to 20% by mass, and more preferably 0.5% to 10% by mass, with respect to the total solid content of the composition.

In addition, the composition may include a polymerizable monomer.

Examples of the polymerizable monomer include a radically polymerizable or cationically polymerizable compound. Among those, a polyfunctional radically polymerizable monomer is preferable. In addition, as the polymerizable monomer, a monomer which is copolymerizable with the liquid crystal compound having a polymerizable group is preferable. Examples of the polymerizable monomer include those described in paragraphs [0018] to [0020] of JP2002-296423A.

The content of the polymerizable monomer in the composition is preferably 1% to 50% by mass, and more preferably 2% to 30% by mass, with respect to the total mass of the liquid crystal compound.

Moreover, the composition may include a surfactant.

Examples of the surfactant include compounds known in the related art, but a fluorine-based compound is preferable. Examples of the compound include the compounds described in paragraphs [0028] to [0056] of JP2001-330725A and the compounds described in paragraphs [0069] to [0126] of JP2003-295212.

Furthermore, the composition includes a solvent. As the solvent, an organic solvent is preferable. Examples of the organic solvent include an amide (for example, N,N-dimethylformamide), a sulfoxide (for example, dimethyl sulfoxide), a heterocyclic compound (for example, pyridine), a hydrocarbon (for example, benzene and hexane), an alkyl halide (for example, chloroform and dichloromethane), an ester (for example, methyl acetate, ethyl acetate, and butyl acetate), a ketone (for example, acetone and methyl ethyl ketone), and an ether (for example, tetrahydrofuran and 1,2-dimethoxyethane). In addition, two or more kinds of the organic solvents may be used in combination.

Moreover, the composition may include various alignment control agents such as a vertical alignment agent and a horizontal alignment agent. Such an alignment control agent is a compound which is capable of controlling the horizontal or vertical alignment of a liquid crystal compound at an interface.

In addition, the composition may include an adhesion improver, a plasticizer, and a polymer, in addition to the components.

<Production Method>

A method for producing the optically anisotropic film of the embodiment of the present invention is not particularly limited and examples thereof include known methods.

Among those, from the viewpoint that in-plane retardation is easily controlled, a method in which a composition including a liquid crystal compound having a polymerizable group (hereinafter also simply referred to as a “polymerizable liquid crystal compound”) and an infrared absorbing dye is applied to form a coating film, the coating film is subjected to an alignment treatment to align the polymerizable liquid crystal compound, and the obtained coating film is subjected to a curing treatment (irradiation with ultraviolet rays (light irradiation treatment) or a heating treatment) to form an optically anisotropic film is preferable.

Hereinafter, the procedure of the method will be described in detail.

First, a composition is applied onto a support to form a coating film and the coating film is subjected to an alignment treatment to align the polymerizable liquid crystal compound.

The composition used includes the polymerizable liquid crystal compound. The polymerizable liquid crystal compound has the same definition as above.

The support used is a member having a function as a base material for applying a composition thereon. The support may be a temporary support which is peeled after applying the composition and performing curing.

As the support (temporary support), a glass substrate may be used, in addition to a plastic film. Examples of a material constituting the plastic film include a polyester resin such as polyethylene terephthalate (PET), a polycarbonate resin, a (meth)acryl resin, an epoxy resin, a polyurethane resin, a polyamide resin, a polyolefin resin, a cellulose derivative, a silicone resin, and polyvinyl alcohol (PVA).

The thickness of the support only needs to be about 5 m to 1,000 μm, preferably 10 to 250 μm, and more preferably 15 to 90 μm.

Moreover, an alignment layer may be arranged on the support, as desired.

The alignment layer generally includes a polymer as a main component. Polymer materials for an alignment layer are described in many documents and a large number of commercially available products thereof can be obtained. As the polymer material for an alignment layer, polyvinyl alcohol, polyimide, or a derivative thereof is preferable.

In addition, it is preferable that the alignment layer is subjected to a known rubbing treatment.

The thickness of the alignment layer is preferably 0.01 to 10 μm, and more preferably 0.01 to 1 μm.

Examples of a method for applying the composition include a curtain coating method, a dip coating method, a spin coating method, a printing coating method, a spray coating method, a slot coating method, a roll coating method, a slide coating method, a blade coating method, a gravure coating method, and a wire bar method. A single layer coating is preferable in a case of performing coating by any of these methods.

The coating film formed on the support is subjected to an alignment treatment to align the polymerizable liquid crystal compound in the coating film.

The alignment treatment can be performed by drying the coating film at room temperature or heating the coating film. In a case of a thermotropic liquid crystal compound, a liquid crystal phase formed with the alignment treatment can generally be transferred by a change in a temperature or pressure. In a case of a lyotropic liquid crystal compound, the liquid crystal phase can also be transferred according to a compositional ratio such as the amount of a solvent.

Furthermore, the condition in a case of heating the coating film is not particularly limited, but the heating temperature is preferably 50° C. to 250° C., and more preferably 50° C. to 150° C., and the heating time is preferably 10 seconds to 10 minutes.

Moreover, before performing a curing treatment (light irradiation treatment) which will be described later, after heating the coating film, the coating film may be cooled, as desired. The cooling temperature is preferably 20° C. to 200° C., and more preferably 30° C. to 150° C.

In addition, a difference between the heating temperature of the above-mentioned coating film and the cooling temperature of the above-mentioned coating film is not particularly limited, but is preferably 40° C. or more. An upper limit thereof is not particularly limited, but may be 150° C. or lower.

Among those, in order to heat the coating film, followed by cooling, before performing the curing treatment, it is preferable that the heating temperature TA of the coating film is 50° C. to 250° C. and the cooling temperature TB is in a range of Heating temperature TA×0.4 to Heating temperature TA×0.7.

Next, the coating film in which the polymerizable liquid crystal compound has been aligned is subjected to a curing treatment.

A method for the curing treatment to be carried out on the coating film in which the polymerizable liquid crystal compound has been aligned is not particularly limited, and examples thereof include a light irradiation treatment and a heating treatment. Among those, from the viewpoint of manufacturing suitability, the light irradiation treatment is preferable, and an ultraviolet irradiation treatment is more preferable.

An irradiation condition for the light irradiation treatment is not particularly limited, but an irradiation dose of 50 to 1,000 mJ/cm² is preferable.

In the production method, by adjusting various conditions, the arrangement state of the infrared absorbing dye, and the like can be adjusted, and as a result, the optical characteristics of the optically anisotropic film can be adjusted.

For example, by adjusting a heating temperature upon alignment of the liquid crystal compound after applying a composition onto the support to form a coating film and a cooling temperature upon cooling after heating, the arrangement state of the infrared absorbing dye, and the like can be adjusted, and as a result, the optical characteristics of the optically anisotropic film can be adjusted.

(Applications)

The above-mentioned optically anisotropic film can be applied to various applications, and it can also be used as, for example, a so-called λ/4 plate or λ/2 plated by adjusting the in-plane retardation of the optically anisotropic film.

Furthermore, the λ/4 plate is a plate having a function of converting linearly polarized light having a specific wavelength into circularly polarized light (or converting circularly polarized light into linearly polarized light). More specifically, the λ/4 plate is a plate in which an in-plane retardation Re at a predetermined wavelength of λ nm is λ/4 (or an odd number of times thereof).

The in-plane retardation (Re(550)) of the λ/4 plate at a wavelength of 550 nm may have an error of about 25 nm from an ideal value (137.5 nm) at a center, and is, for example, preferably 110 to 160 nm, and more preferably 120 to 150 nm.

In addition, the λ/2 plate is an optically anisotropic film in which the in-plane retardation Re(λ) at a specific wavelength of X nm satisfies Re(λ)≈λ/2. This formula only needs to be satisfied at a wavelength (for example, 550 nm) in the visible region. Among those, it is preferable that the in-plane retardation Re(550) at a wavelength of 550 nm satisfies the following relationship.

210 nm≤Re(550)≤300 nm

The optically anisotropic film and an optical film including the optically anisotropic film may be included in a display device. That is, examples of more specific applications of the optically anisotropic film include an optical compensation film for optical compensation of a liquid crystal cell, and an antireflection film for use in a display device such as an organic electroluminescence display device.

Among those, in a preferred aspect of the optical film, a circularly polarizing plate including an optically anisotropic film and a polarizer can be mentioned. This circularly polarizing plate can be suitably used as the antireflection film. That is, it is possible to further suppress a reflection tint in a display device including a display element (for example, an organic electroluminescence display element) and a circularly polarizing plate arranged on the display element.

Furthermore, the optically anisotropic film of the embodiment of the present invention is suitably used in an optical compensation film of an in plane switching (IPS) type liquid crystal display device, and can improve a tint change as viewed from a tilt direction and a light leakage upon black display.

Examples of the optical film including the optically anisotropic film include a circularly polarizing plate including a polarizer and an optically anisotropic film, as described above.

The polarizer only needs to be a member (linear polarizer) having a function of converting light into specific linearly polarized light, and an absorptive type polarizer can be usually used.

Examples of the absorptive type polarizer include an iodine-based polarizer, a dye-based polarizer using a dichroic dye, and a polyene-based polarizer. The iodine-based polarizer and the dye-based polarizer are classified into a coating type polarizer and a stretching type polarizer, both of which can be applied, but a polarizer which is manufactured by allowing polyvinyl alcohol to adsorb iodine or a dichroic dye and performing stretching is preferable.

A relationship between the absorption axis of the polarizer and the slow axis of the optically anisotropic film is not particularly limited, but in a case where the optically anisotropic film is a λ/4 plate and the optical film is used as a circularly polarizing film, an angle formed between the absorption axis of the polarizer and the slow axis of the optically anisotropic film is preferably 45±10°.

### EXAMPLES

Hereinafter, the features of the present invention will be described in more detail with reference to Examples and Comparative Examples. The materials, the amounts used, the proportions, the treatment details, the treatment procedure, and the like shown in Examples below can be modified as appropriate as long as the modifications do not depart from the spirit of the present invention. Therefore, the scope of the present invention should not be construed as being limited to specific examples shown below.

<Synthesis of Infrared Absorbing Dye IR-1>

According to the following scheme, an infrared absorbing dye IR-1 was synthesized.

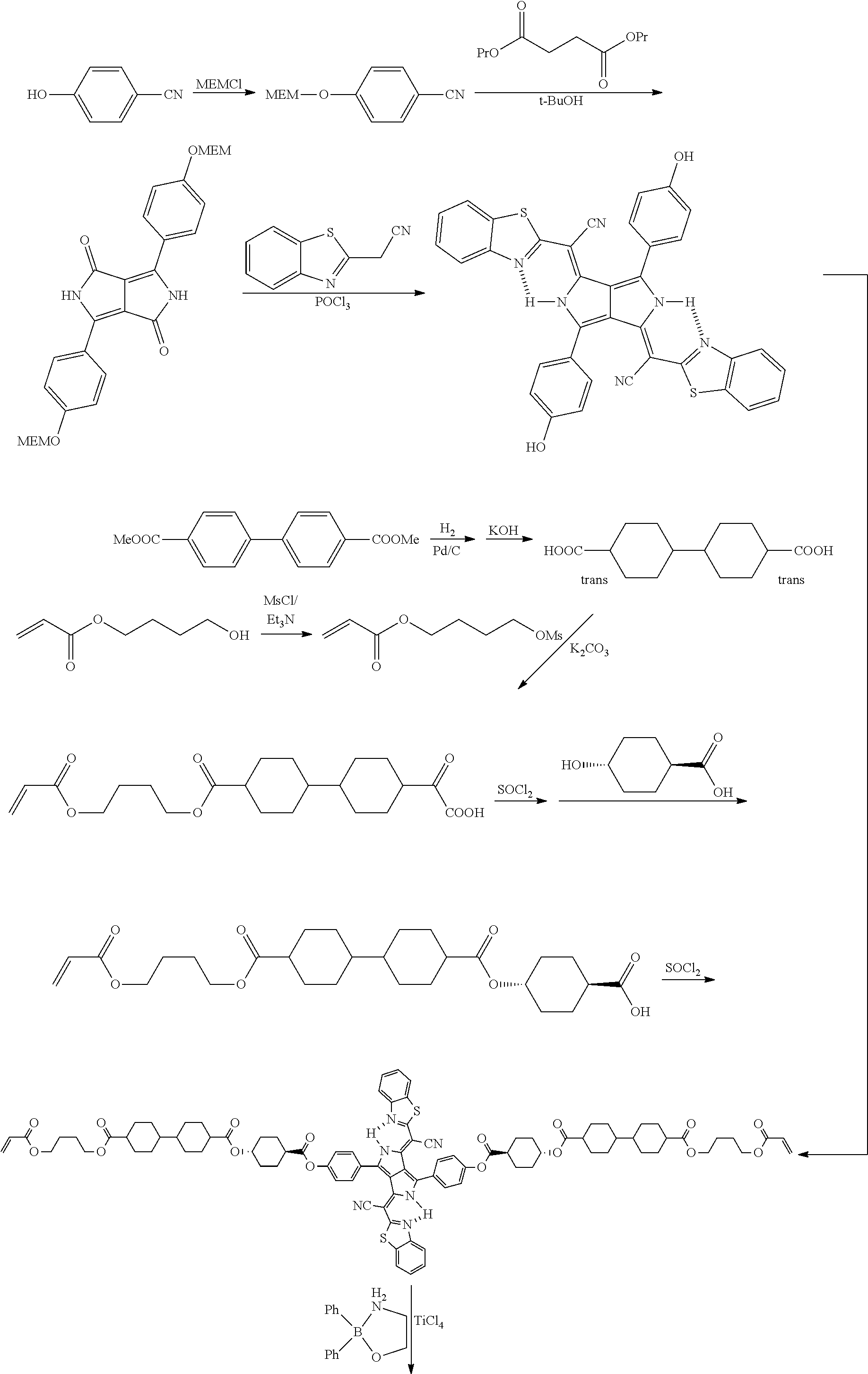

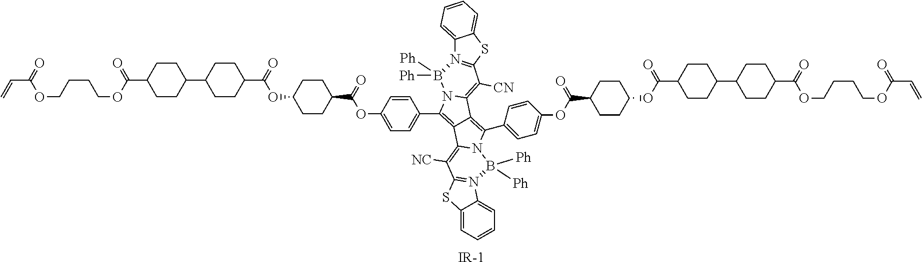

According to the following scheme, the infrared absorbing dye IR-1 was synthesized with reference to JP2011-068731 A.

An infrared absorbing dye IR-2 was synthesized with reference to <Synthesis of Infrared Absorbing Dye IR-1>.

Infrared absorbing dye IR-2

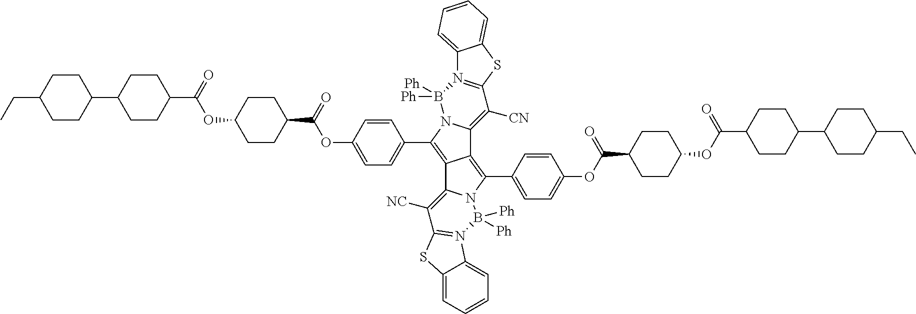

The infrared absorbing dye IR-1 and an infrared absorbing dye IR-2 were each dissolved in chloroform at a concentration of 10⁻⁴ mol/l, and a solution thus obtained was used to measure spectral characteristics. In addition, for the measurement, a spectrophotometer (MPC-3100 manufactured by SHIMADZU Corporation) was used.

A maximum absorption wavelength of the infrared absorbing dye IR-1 was 780 nm and a maximum absorption wavelength of the infrared absorbing dye IR-2 was 780 nm.

An integrated value of the absorbances in a wavelength range of 700 to 900 nm of the infrared absorbing dye IR-1 was larger than an integrated value of the absorbances in a wavelength range of 400 to 700 nm of the infrared absorbing dye IR-1.

An integrated value of the absorbances in a wavelength range of 700 to 900 nm of the infrared absorbing dye IR-2 was larger than an integrated value of the absorbances in a wavelength range of 400 to 700 nm of the infrared absorbing dye IR-2.

### Example 1

A cellulose acylate film Ti (“TD40UL” manufactured by Fujifilm Corporation) was allowed to pass through a dielectric heating roll at a temperature of 60° C. and the film surface temperature was raised to 40° C. Thereafter, an alkali solution having the composition shown below was applied to one surface of the film using a bar coater at a coating amount of 14 ml/m² and the film was heated at 110° C. Next, the obtained film was transported for 10 seconds under a steam type far-infrared heater manufactured by NORITAKE Co., Ltd. Next, pure water was applied onto a surface of the film at 3 ml/m² using the same bar coater. Subsequently, the obtained film was three times repeatedly subjected to washing with water using a fountain coater and dehydration using an air knife, and then the film was transported to a drying zone at 70° C. for 10 seconds and dried to manufacture an alkali saponification-treated cellulose acylate film, which was used as a support.

(Alkali Solution)

| | | |
|---|---|---|
| Potassium hydroxide | 4.7 | parts by mass |
| Water | 15.8 | parts by mass |
| Isopropanol | 63.7 | parts by mass |
| Surfactant | 1.0 | part by mass |
| (C₁₄H₂₉O(CH₂CH₂O)₂₀H) | | |
| Propylene glycol | 14.8 | parts by mass |

A coating liquid for an alignment layer having the following composition was continuously applied onto the support with a #14 wire bar. The support having the coating film formed thereon was dried with hot air at 60° C. for 60 seconds and dried with a hot air at 100° C. for 120 seconds. Subsequently, the coating film after the drying was continuously subjected to a rubbing treatment to form an alignment layer. At this time, the longitudinal direction of the long film and the transporting direction were in parallel with each other, and the rotating shaft of the rubbing roller relative to the longitudinal direction of the film was set to a direction of 45° clockwise.

(Coating Liquid for Alignment Layer)

| | | |
|---|---|---|
| The following modified polyvinyl alcohol | 10.0 | parts by mass |
| Water | 371.0 | parts by mass |
| Methanol | 119.0 | parts by mass |
| Glutaraldehyde | 0.5 | parts by mass |
| Polymerization initiator (IRGACURE 2959, manufactured by BASF) | 0.3 | parts by mass |

(in the following structural formula, the ratio is a molar ratio)

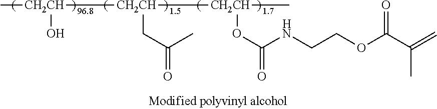

The following coating liquid 1 for an optically anisotropic film was prepared.

| | | |
|---|---|---|
| The following liquid crystal compound L-1 | 60 | parts by mass |
| The following liquid crystal compound L-2 | 40 | parts by mass |
| Infrared absorbing dye IR-I | 20 | parts by mass |
| Photopolymerization initiator 1 (IRGACURE OXE01, manufactured by BASF) | 3.0 | parts by mass |
| Photopolymerization initiator 2 (IRGACURE 184, manufactured by BASF) | 3.0 | parts by mass |
| The following fluorine-containing compound F-1 | 0.2 | parts by mass |
| Cyclopentanone | 227.1 | parts by mass |

Liquid crystalline compound L-1 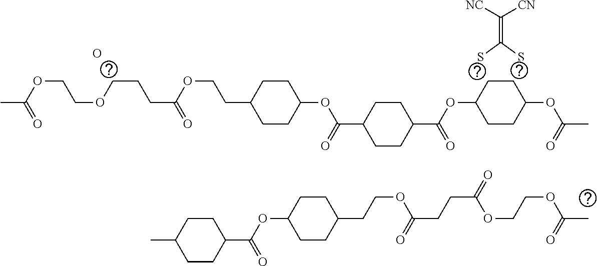
Liquid crystalline compound L-2 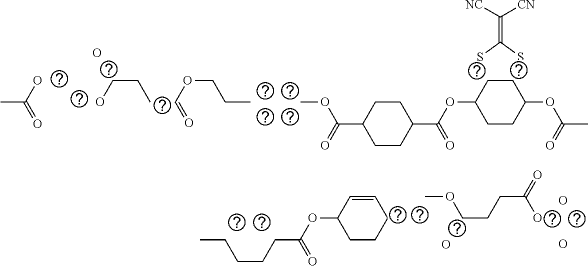
Fluorine-containing compound F-1

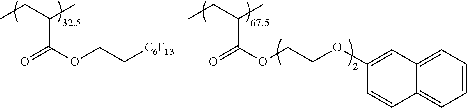

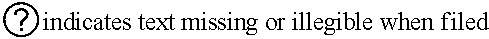

The coating liquid 1 for an optically anisotropic film was applied onto the alignment layer with a wire bar to form a coating film, and the coating film was heated at 100° C. for 5 minutes and cooled to 60° C. Thereafter, nitrogen purge was performed such that an atmosphere with an oxygen concentration of 1.0% by volume or less was formed, and the coating film was irradiated with ultraviolet rays at an irradiation does of 500 mJ/cm² using a high-pressure mercury lamp to manufacture an optically anisotropic film.

The optical characteristics of the obtained optically anisotropic film were measured using AxoScan OPMF-1 (manufactured by Opto Science, Inc.), and it was thus found that Re(550) was 140 nm, Re(450)/Re(550) was 0.82, and Re(650)Re(550) was 1.10.

Furthermore, an absorption in the infrared region was confirmed using a spectrophotometer (MPC-3100 (manufactured by SHIMADZU Corporation)) equipped with a polarizer for infrared rays, and it was thus confirmed that the absorption in the direction in parallel with the fast axis of the optically anisotropic film was larger than the absorption in the direction in parallel with the slow axis at a wavelength of 700 to 900 nm.

In addition, the orientational order parameter S₀ of the optically anisotropic film at the maximum absorption wavelength of the infrared absorbing dye IR-1 was −0.25.

### Example 2

An optically anisotropic film was obtained according to the same procedure as in Example 1, except that the use amount of the infrared absorbing dye IR-1 was changed from 20 parts by mass to 40 parts by mass.

The optical characteristics of the obtained optically anisotropic film were measured using AxoScan OPMF-1 (manufactured by Opto Science, Inc.), and it was thus found that Re(550) was 143 nm, Re(450)/Re(550) was 0.83, and Re(650)/Re(550) was 1.13.

Furthermore, an absorption in the infrared region was confirmed using a spectrophotometer (MPC-3100 (manufactured by SHIMADZU Corporation)) comprising a polarizer for infrared rays, and it was thus confirmed that the absorption in the direction in parallel with the fast axis of the optically anisotropic film was larger than the absorption in the direction in parallel with the slow axis at a wavelength of 700 to 900 nm.

In addition, the orientational order parameter S₀ of the optically anisotropic film at the maximum absorption wavelength of the infrared absorbing dye IR-1 was −0.20.

### Example 3

An optically anisotropic film was obtained according to the same procedure as in Example 1, except that the infrared absorbing dye IR-1 was replaced by IR-2.

The optical characteristics of the obtained optically anisotropic film were measured using AxoScan OPMF-1 (manufactured by Opto Science, Inc.), and it was thus found that Re(550) was 143 nm, Re(450)/Re(550) was 0.82, and Re(650)/Re(550) was 1.10.

Furthermore, an absorption in the infrared region was confirmed using a spectrophotometer (MPC-3100 (manufactured by SHIMADZU Corporation)) comprising a polarizer for infrared rays, and it was thus confirmed that the absorption in the direction in parallel with the fast axis of the optically anisotropic film was larger than the absorption in the direction in parallel with the slow axis at a wavelength of 700 to 900 nm.

In addition, the orientational order parameter S₀ of the optically anisotropic film at the maximum absorption wavelength of the infrared absorbing dye IR-1 was −0.20.

### Comparative Example 1

An optically anisotropic film was obtained according to the same procedure as in Example 1, except that the infrared absorbing dye IR-1 was not used.

The optical characteristics of the obtained optically anisotropic film were measured using AxoScan OPMF-1 (manufactured by Opto Science, Inc.), and it was thus found that Re(550) was 140 nm, Re(450)/Re(550) was 0.82, and Re(650)/Re(550) was 1.04.

Furthermore, an absorption in the infrared region was confirmed using a spectrophotometer (MPC-3100 (manufactured by SHIMADZU Corporation)) comprising a polarizer for infrared rays, and it was thus confirmed that the absorption in the direction in parallel with the fast axis of the optically anisotropic film was the same as the absorption in the direction in parallel with the slow axis at a wavelength of 700 to 900 nm.

As shown in Examples 1 to 3, the optically anisotropic film exhibiting predetermined optical characteristics had a higher Re(650)/Re(550) (1.10 or more) with a lower Re(450)/Re(550) (0.85 or less), and thus, an optically anisotropic film having more ideal dispersion characteristics was obtained.

### Example 4

A polyimide alignment film SE-130 (manufactured by Nissan Chemical Industries, Ltd.) was applied onto a washed glass substrate by a spin coating method. After the coating film was dried and then calcined at 250° C. for 1 hour, the coating film was subjected to a rubbing treatment to form an alignment layer.

The following coating liquid 4 for an optically anisotropic film was prepared.

| | | |
|---|---|---|
| The following liquid crystal compound L-3 | 100 | parts by mass |
| Infrared absorbing dye IR-3 | 10 | parts by mass |
| Photopolymerization initiator S-1 | 2.0 | parts by mass |
| The fluorine-containing compound F-1 | 1.0 | part by mass |
| Chloroform | 571.8 | parts by mass |

Moreover, a group adjacent to the acryloyloxy group in the structural formulae of the liquid crystal compound L-3 and the infrared absorbing dye IR-3 represents a propylene group (a group in which the methyl group is substituted with an ethylene group), and the liquid crystal compound L-3 and the infrared absorbing dye IR-3 represent a mixture of position isomers in which the positions of the methyl groups are different.

Liquid crystal compound L-3 (the following structural formula)

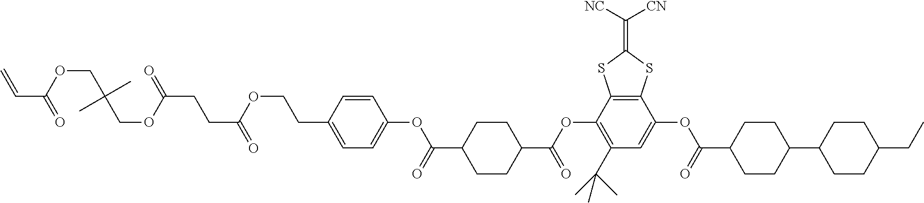 [SMILES: C=CC(=O)OCC(C)(C)COC(=O)CCC(=O)OCCc1ccc(OC(=O)C2CCC(C(=O)Oc3c(C(C)(C)C)cc(OC(=O)C4CCC(C5CCC(CC)CC5)CC4)c4c3SC(=C(C#N)C#N)S4)CC2)cc1]

Infrared absorbing dye IR-3 (the following a structural formula)

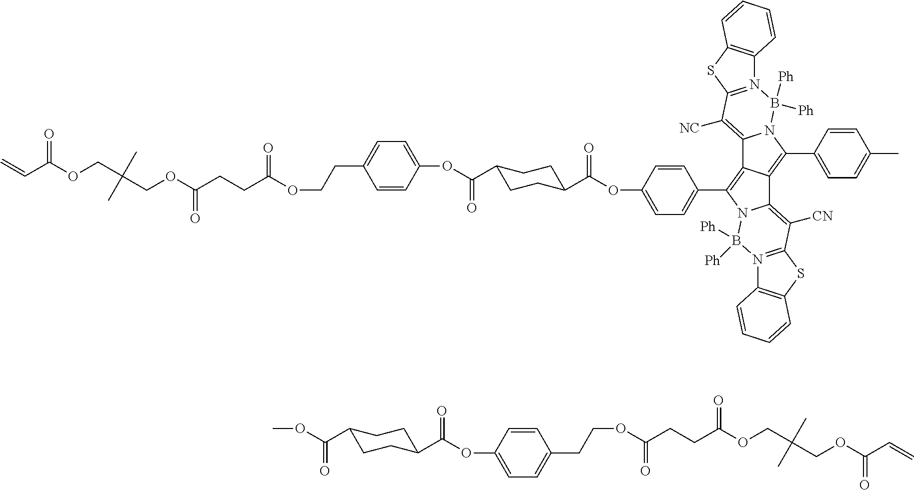

Photopolymerization initiator S-1 (the following a structural formula)

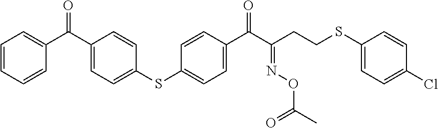 [SMILES: CC(=O)O/N=C(\CCSc1ccc(Cl)cc1)C(=O)c1ccc(Sc2ccc(C(=O)c3ccccc3)cc2)cc1]

The coating liquid 4 for an optically anisotropic film was applied onto the alignment layer by a spin coating method to form a coating film, and the coating film was heated at 120° C. for 1 minute and cooled to 60° C.

Thereafter, nitrogen purge was performed such that an atmosphere with an oxygen concentration of 1.0% by volume or less was formed, and the coating film was irradiated with ultraviolet rays at an irradiation does of 500 mJ/cm² using a high-pressure mercury lamp to manufacture an optically anisotropic film.

The optical characteristics of the obtained optically anisotropic film were measured using AxoScan OPMF-1 (manufactured by Opto Science, Inc.), and it was thus found that Re(550) was 140 nm, Re(450)/Re(550) was 0.78, and Re(650)/Re(550) was 1.25.

Furthermore, an absorption in the infrared region was confirmed using a spectrophotometer (MPC-3100 (manufactured by SHIMADZU Corporation)) comprising a polarizer for infrared rays, and it was thus confirmed that the absorption in the direction in parallel with the fast axis of the optically anisotropic film was larger than the absorption in the direction in parallel with the slow axis at a wavelength of 700 to 900 nm.

In addition, the orientational order parameter S₀ of the optically anisotropic film at the maximum absorption wavelength of the infrared absorbing dye IR-3 was −0.25.

### Examples 5 to 7 and Comparative Example 2

An optically anisotropic film was manufactured according to the same procedure as in Example 4, except that the type and use amount of the liquid crystal compound, the type and use amount of the infrared absorbing dye, the use amount of the photopolymerization initiator S-1, the use amount of the fluorine-containing compound F-1, and the heating condition and cooling condition upon formation of the coating film were changed as in Table 1.

Re(550), Re(450)/Re(550), Re(650)/Re(550), and the orientational order parameter S₀ of the optically anisotropic film obtained in each of Examples and Comparative Examples are summarized in Table 1.

Furthermore, with regard to the optically anisotropic film obtained in each of Examples 5 to 8, an absorption in the infrared region was confirmed using a spectrophotometer (MPC-3100 (manufactured by SHIMADZU Corporation)) comprising a polarizer for infrared rays, and it was thus confirmed that the absorption in the direction in parallel with the fast axis of the optically anisotropic film was larger than the absorption in the direction in parallel with the slow axis at a wavelength of 700 to 900 nm.

Moreover, the liquid crystal compound and the infrared absorbing dye in Table 1 are as below.

Liquid crystal compound L-4 (structural formula below)

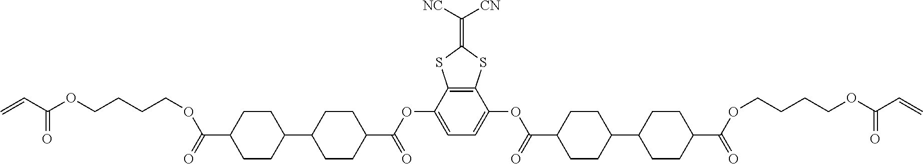 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

Liquid crystal compound L-5 (structural formula below)

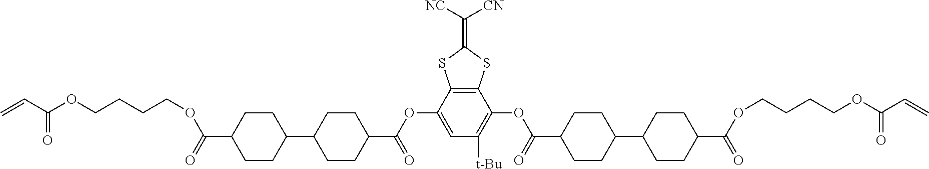 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

Liquid crystal compound L-6 (structural formula below)

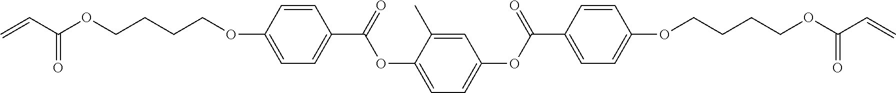 [SMILES: C=CC(=O)OCCCCOc1ccc(C(=O)Oc2ccc(OC(=O)c3ccc(OCCCCOC(=O)C=C)cc3)c(C)c2)cc1]

Infrared absorbing dye IR-4 (structural formula below)

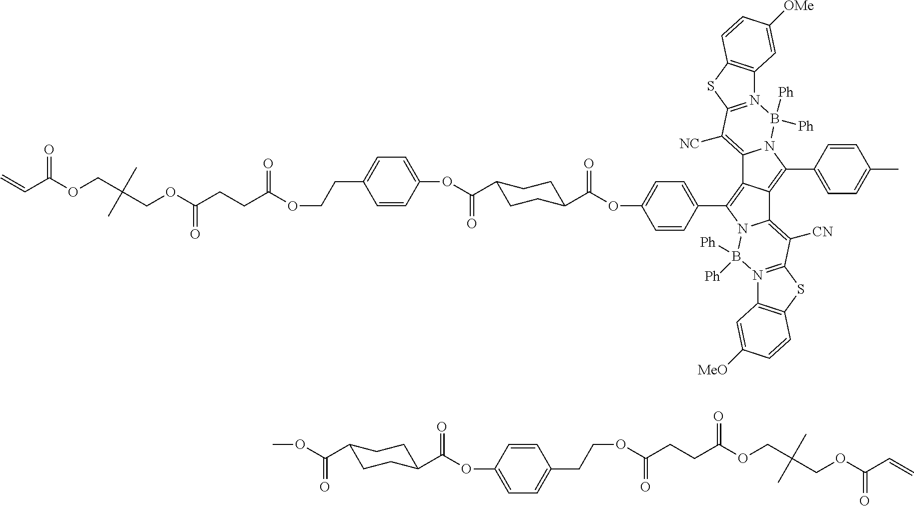

Moreover, a group adjacent to the acryloyloxy group in the structural formula of the infrared absorbing dye IR-4 represents a propylene group (a group in which the methyl group is substituted with an ethylene group), and the infrared absorbing dye IR-4 represents a mixture of position isomers in which the positions of the methyl groups are different.

Moreover, infrared absorbing dyes IR-3 and IR-4 were synthesized with reference to <Synthesis of Infrared Absorbing Dye IR-1>.

The infrared absorbing dye IR-3 and the infrared absorbing dye IR-4 were each dissolved in chloroform at a concentration of 10⁻⁴ mol/l, and a solution thus obtained was used to measure spectral characteristics. In addition, for the measurement, a spectrophotometer (MPC-3100 manufactured by SHIMADZU Corporation) was used.

A maximum absorption wavelength of the infrared absorbing dye IR-3 was 785 nm and a maximum absorption wavelength of the infrared absorbing dye IR-4 was 800 nm.

An integrated value of the absorbances in a wavelength range of 700 to 900 nm of the infrared absorbing dye IR-3 was larger than an integrated value of the absorbances in a wavelength range of 400 to 700 nm of the infrared absorbing dye IR-1.

An integrated value of the absorbances in a wavelength range of 700 to 900 nm of the infrared absorbing dye IR-4 was larger than an integrated value of the absorbances in a wavelength range of 400 to 700 nm of the infrared absorbing dye IR-2.

<Evaluation of Brightness>

A polyvinyl alcohol film having a thickness of 80 μm was immersed in an aqueous iodine solution at an iodine concentration of 0.05% by mass at 30° C. for 60 seconds and dyed. Subsequently, the obtained film was vertically stretched five times its original length while the film was immersed in an aqueous boric acid solution (boric acid concentration: 4% by mass) for 60 seconds, and then the vertically stretched film was dried at 50° C. for 4 minutes to obtain a polarizer having a thickness of 20 μm.

A commercially available cellulose acylate-based film “TD80UL” (manufactured by Fujifilm Corporation) was prepared and immersed in an aqueous sodium hydroxide solution at 1.5 mol/liter at 55° C., and then the obtained film was sufficiently washed with water to remove sodium hydroxide.

Thereafter, the obtained film was immersed in a diluted aqueous sulfuric acid solution at 0.005 mol/liter at 35° C. for one minute, then the obtained film was immersed in water, and the diluted aqueous sulfuric acid solution on the film was sufficiently washed and removed. Thereafter, the washed film was dried at 120° C. to manufacture a polarizer protective film.

The polarizer protective film manufactured above was bonded to one surface of the polarizer manufactured above with a polyvinyl alcohol-based adhesive to manufacture a polarizing plate including the polarizer and the polarizer protective film arranged on one surface of the polarizer.

A pressure sensitive adhesive (SK-2057, manufactured by Soken Chemical & Engineering Co., Ltd.) was applied onto the polarizer (having no polarizer protective film) side in the polarizing plate manufactured above to form a pressure sensitive adhesive layer, and the optically anisotropic film manufactured in each of Examples and Comparative Examples was bonded thereto such that the pressure sensitive adhesive layer and the optically anisotropic layer were adhered to each other, thereby manufacturing a circularly polarizing plate. In addition, an angle formed between the slow axis of the optically anisotropic film and the transmission axis of the polarizer was set to 45°.

Galaxy S4 (manufactured by Samsung) was disintegrated and a part of an antireflection film bonded to the product was peeled and used as a light emitting layer. The circularly polarizing plate manufactured above was bonded to the light emitting layer through a pressure sensitive adhesive while preventing air permeation, thereby manufacturing an organic electroluminescence (EL) display device for evaluation.

At this time, the optical anisotropic layer side of each polarizing plate was set to be the Galaxy S4 side.

(Evaluation of Brightness)

For the evaluation, a maximum light quantity in a wavelength range of 380 to 780 nm in a case where an organic EL display device for evaluation was taken for white display was measured from the normal direction of the organic EL display device. In addition, the evaluation was performed with a relative value in a case where a maximum light quantity of a system to which an infrared absorbing dye was not added (Comparative Example 2) was taken as 100%. In a case where the numerical value is large, the brightness is excellent. The results are summarized in Table 1.

(Evaluation of Front Reflectance)

A front reflection was measured in a specular component excluded (SCE) mode using a colorimeter (CM-2022 manufactured by Konica Minolta, Inc.), and the obtained Y values were evaluated according to the following standard.

A: A case where the Y value is 0.23 or less

B: A case where the Y value is more than 0.23 and 0.27 or less

C: A case where the Y value is more than 0.27

In Table 1, “Type (parts by mass)” in the section of “Liquid Crystal Compound” indicates the type and use amount (parts by mass) of a liquid crystal compound. For example, in Example 7, it is shown that 42 parts by mass of the liquid crystal compound L-4, 42 parts by mass of the liquid crystal compound L-5, and 16 parts by mass of the liquid crystal compound L-6 were used.

Moreover, the section of “Infrared absorbing dye (parts by mass)” shows the type and use amount (parts by mass) of an infrared absorbing dye. For example, in Example 4, it is shown that 10 parts by mass of the infrared absorbing dye IR-3 was used.

Furthermore, the section of “Coating film forming condition” shows each of the heating temperature and the cooling temperature in a case where the coating liquid for an optically anisotropic film is applied onto an alignment layer by a spin coating method to form a coating film, and the coating film is heated and cooled.

In addition, the evaluation “−” of the orientational order parameter of Comparative Example 2 indicates that the measurement could not be performed since there was no absorption in the infrared region.

TABLE 1

| | Liquid crystal compound | | | Infrared | Fluorine-containing | Photopolymerization | Coating film forming | |
|---|---|---|---|---|---|---|---|---|
| | Type | Type | Type | absorbing | compound F-1 | initiator S-1 | condition | |
| | (parts by | (parts by | (parts by | dye (parts | Used amount (parts | Used amount (parts | Heating | Cooling |
| | mass) | mass) | mass) | by mass) | by mass) | by mass) | temperature | temperature |
| Example 4 | L-3 | — | — | IR-3 (10) | 1 | 2 | 120° C. | 60° C. |
| | (100) | | | | | | | |
| Example 5 | L-3 | — | — | IR-3 (10) | 1 | 2 | 200° C. | 60° C. |
| | (100) | | | | | | | |
| Example 6 | L-3 | — | — | IR-3 (5) | 1 | 2 | 100° C. | 60° C. |
| | (100) | | | | | | | |
| Example 7 | L-4 (42) | L-5 (42) | L-6 (42) | IR-4 (5) | 0.2 | 0.5 | 240° C. | 120° C. |
| Comparative | L-4 (42) | L-5 (42) | L-6 (42) | — | 0.2 | 0.5 | 200° C. | 120° C. |
| Example 2 | | | | | | | | |

| | Optical characteristics | | | | | |
|---|---|---|---|---|---|---|
| | Re(550) | Re(450)/ | Re(650)/ | | Evaluation of | Front |
| | (nm) | Re(550) | Re(550) | S₀ | brightness | reflection |
| Example 4 | 140 | 0.78 | 1.25 | −0.25 | 92% | B |
| Example 5 | 140 | 0.80 | 1.16 | −0.15 | 90% | A |
| Example 6 | 140 | 0.78 | 1.17 | −0.22 | 97% | A |
| Example 7 | 140 | 0.82 | 1.13 | −0.29 | 96% | A |
| Comparative | 140 | 0.84 | 1.03 | — | 100% | C |
| Example 2 | | | | | | |

As shown in Examples 4 to 7, the optically anisotropic film exhibiting predetermined optical characteristics had larger Re(650)/Re(550) (1.09 or more) with smaller Re(450)/Re(550) (0.85 or less), and thus, an optically anisotropic film having more ideal dispersion characteristics was obtained.

Among those, from the comparisons between Example 5 and other Examples, in a case where the orientational order parameter S₀ satisfies the relationship of Formula (B): −0.50<S₀<-0.15, the effects were more excellent.

What is claimed is:

1. An optically anisotropic film formed from a composition including a liquid crystal compound and an infrared absorbing dye,
wherein the optically anisotropic film satisfies a relationship of Formula (A), and
an absorption at a wavelength of 700 to 900 nm in the fast axis direction of the optically anisotropic film is larger than an absorption at a wavelength of 700 to 900 nm in the slow axis direction of the optically anisotropic film,
Re(450)/Re(550)<1 Formula (A)
in the formula, Re(450) represents an in-plane retardation of the optically anisotropic film at a wavelength of 450 nm and Re(550) represents an in-plane retardation of the optically anisotropic film at a wavelength of 550 nm.

2. The optically anisotropic film according to claim 1,
wherein an orientational order parameter S₀ of the optically anisotropic film at a maximum absorption wavelength in a wavelength range of 700 to 900 nm of the infrared absorbing dye satisfies a relationship of Formula (B),
−0.50<S₀<−0.15. Formula (B)

3. An optically anisotropic film formed from a composition including a liquid crystal compound and an infrared absorbing dye,
wherein an orientational order parameter S₀ of the optically anisotropic film at a maximum absorption wavelength in a wavelength range of 700 to 900 nm of the infrared absorbing dye satisfies a relationship of Formula (B), and
an absorption at a wavelength of 700 to 900 nm in the fast axis direction of the optically anisotropic film is larger than an absorption at a wavelength of 700 to 900 nm in the slow axis direction of the optically anisotropic film,
−0.50<S₀<−0.15. Formula (B)

4. The optically anisotropic film according to claim 1,
wherein an integrated value of the absorbances in a wavelength range of 700 to 900 nm of the infrared absorbing dye is larger than an integrated value of the absorbances in a wavelength range of 400 to 700 nm of the infrared absorbing dye.

5. The optically anisotropic film according to claim 1,
wherein the infrared absorbing dye is a compound represented by Formula (1), 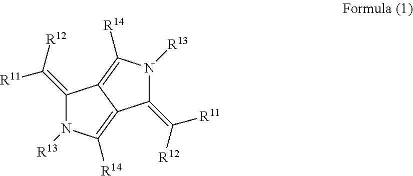
in the formula, R¹¹ and R¹² each independently represent a hydrogen atom or a substituent, at least one thereof is an electron-withdrawing group, R¹¹ and R¹² may be bonded to each other to form a ring, R¹³'s each independently represent a hydrogen atom, an alkyl group, an aryl group, a heteroaryl group, a substitutional boron, or a metal atom, or may be covalently bonded or bed coordinately bonded with R¹¹, and R¹⁴'s each independently represent a group having a mesogenic group.

6. The optically anisotropic film according to claim 1,
wherein an in-plane retardation at a wavelength of 550 nm is 110 to 160 nm.

7. A circularly polarizing plate comprising:
the optically anisotropic film according to claim 6; and
a polarizer.

8. A display device comprising:
a display element; and
the circularly polarizing plate according to claim 7, arranged on the display element.

9. The optically anisotropic film according to claim 2,
wherein an integrated value of the absorbances in a wavelength range of 700 to 900 nm of the infrared absorbing dye is larger than an integrated value of the absorbances in a wavelength range of 400 to 700 nm of the infrared absorbing dye.

10. The optically anisotropic film according to claim 3,
wherein an integrated value of the absorbances in a wavelength range of 700 to 900 nm of the infrared absorbing dye is larger than an integrated value of the absorbances in a wavelength range of 400 to 700 nm of the infrared absorbing dye.

11. The optically anisotropic film according to claim 2,
wherein the infrared absorbing dye is a compound represented by Formula (1), 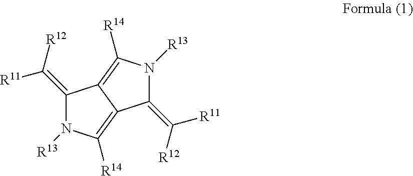
in the formula, R¹¹ and R¹² each independently represent a hydrogen atom or a substituent, at least one thereof is an electron-withdrawing group, R¹¹ and R¹² may be bonded to each other to form a ring, R¹³'s each independently represent a hydrogen atom, an alkyl group, an aryl group, a heteroaryl group, a substitutional boron, or a metal atom, or may be covalently bonded or bed coordinately bonded with R¹¹, and R¹⁴'s each independently represent a group having a mesogenic group.

12. The optically anisotropic film according to claim 3,
wherein the infrared absorbing dye is a compound represented by Formula (1), 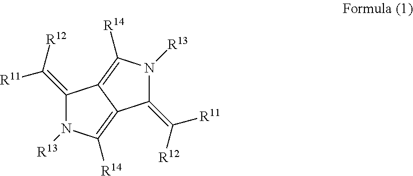
in the formula, R¹¹ and R¹² each independently represent a hydrogen atom or a substituent, at least one thereof is an electron-withdrawing group, R¹¹ and R¹² may be bonded to each other to form a ring, R¹³'s each independently represent a hydrogen atom, an alkyl group, an aryl group, a heteroaryl group, a substitutional boron, or a metal atom, or may be covalently bonded or bed coordinately bonded with R¹¹, and R¹⁴'s each independently represent a group having a mesogenic group.

13. The optically anisotropic film according to claim 4,
wherein the infrared absorbing dye is a compound represented by Formula (1), 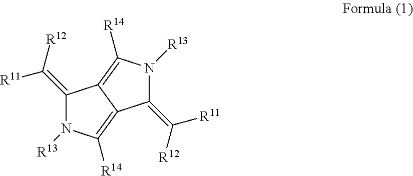
in the formula, R¹¹ and R¹² each independently represent a hydrogen atom or a substituent, at least one thereof is an electron-withdrawing group, R¹¹ and R¹² may be bonded to each other to form a ring, R¹³'s each independently represent a hydrogen atom, an alkyl group, an aryl group, a heteroaryl group, a substitutional boron, or a metal atom, or may be covalently bonded or bed coordinately bonded with R¹¹, and R¹⁴'s each independently represent a group having a mesogenic group.

14. The optically anisotropic film according to claim 2,
wherein an in-plane retardation at a wavelength of 550 nm is 110 to 160 nm.

15. The optically anisotropic film according to claim 3,
wherein an in-plane retardation at a wavelength of 550 nm is 110 to 160 nm.

16. The optically anisotropic film according to claim 4,
wherein an in-plane retardation at a wavelength of 550 nm is 110 to 160 nm.

17. The optically anisotropic film according to claim 5,
wherein an in-plane retardation at a wavelength of 550 nm is 110 to 160 nm.
